(19) United States
(12) Patent Application Publication
(10) Pub. No.: US 2008/0195461 A1
(43) Pub. Date: Aug. 14, 2008

(54) System and method for host web site profiling

(75) Inventors: Zhi Li, San Ramon, CA (US); Canhui Ou, Danville, CA (US); Raghvendra Savoor, Walnut Creek, CA (US); Sun-uk Park, Union City, CA (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/706,147

(22) Filed: Feb. 13, 2007

(51) Int. Cl. G06F 17/30

(52) U.S. Cl. 705/10

(57) ABSTRACT

A computerized method for selecting a host web site for hosting advertising data is disclosed the method including characterizing in a data communications network, data communications for a plurality of end user devices for each of a plurality of subscribers to the data communication network between the data communication network and each of a plurality of potential host web sites; profiling each of the plurality of potential host web sites for advertising performance based on the characterizing data communications and subscriber profile data for the plurality of subscribers stored in the data communications network; and selecting one of the plurality of potential host web sites as a selected host web site for the advertising data based on the selected host web site advertising performance. A system and a computer program are also disclosed for performing the method. A data structure is disclosed for providing a functional and structural interrelationship between the data structure, data in the data structure and a processor.

### FIELD OF THE DISCLOSURE

The present disclosure relates to profiling internet activity in a data communications network.

### BACKGROUND

Advertisers often present advertisements to users of networked computer systems (e.g., Internet-connected computer systems) in hopes that the users of the networked computer systems will become interested in the advertised products. At times, advertisers may present advertisements that are viewed by users and as a result generate user interest in the advertised product. However, at other times, and perhaps more frequently, viewed advertisements generate little, if any, user interest in advertised products. In some cases, users simply ignore advertisements, not viewing them at all.

In the past, the reduced effectiveness of advertisements presented on computer networks was in part due to advertisers having reduced amounts of contextual data associated with possible advertisement recipients. In a broadcast or cable television environment, an advertiser may, at the very least, have contextual data on the channel that will present an advertisement. In many cases, an advertiser will also have contextual data on the programming and time of day during which an advertisement will be presented. However, computer networks, such as the Internet, may include voluminous amounts of information, only a small portion of which may be of interest to a particular user. An advertiser may have had no way to determine what a particular user is interested in and thus present appropriate advertisements.

### BRIEF DESCRIPTION OF THE DRAWINGS

FIG. 1 depicts an illustrative embodiment of a data communication network providing internet service and data communications between network subscribers and web sites on the world wide web;

FIG. 2 depicts a flow chart of functions perform in another illustrative embodiment;

FIG. 3 depicts a flow chart of functions perform in another illustrative embodiment;

FIG. 4 depicts a flow chart of functions perform in another illustrative embodiment;

FIG. 5 depicts a data structure embedded in a computer readable medium for providing a functional and structural interrelationship between the data structure, data in the data structure and a computer or processor in another illustrative embodiment; and

FIG. 6 is an illustrative embodiment of a machine for performing functions disclosed.

### DETAILED DESCRIPTION

In a particular illustrative embodiment a computerized method is disclosed for selecting a host web site for hosting advertising data. The method includes characterizing in a data communications network data communications for a plurality of end user devices for each of a plurality of subscribers to the data communication network between the data communication network and each of a plurality of potential host web sites; profiling each of the plurality of potential host web sites for advertising performance based on the characterizing data communications and subscriber profile data for the plurality of subscribers stored in the data communications network; and selecting a subscriber profile for the one of the plurality of potential host web sites as a selected host web site for the advertising data based on the selected host web site advertising performance.

In another particular illustrative embodiment the profiling further includes ranking the plurality of potential host web sites for advertising performance based on data selected from the group consisting of sales by advertising type, sales by advertising category, sales by demographic category, sales by advertising type in demographic category, related sales by advertising type and advertising category in demographic category, direct sales by advertising type and category in demographic category and total visitors in demographic category.

In another particular illustrative embodiment the data communications network is an internet protocol television (IPTV) network and characterizing the data communications further comprises characterizing transactions between IPTV network subscribers and the plurality of potential host web sites into categories selected from the group consisting of advertising categories, advertising types and subscriber categories.

In another particular illustrative embodiment the transactions are characterized based on a transaction type selected from the group consisting of direct sales, related sales, click through, number of visits to a web site, duration of visit on a web site and subsequent related visit to an advertiser web site hosted by a potential host web site.

In another particular illustrative embodiment the advertising categories are selected from the group consisting of sports, fashion, finance and news and the advertising types are selected from the group consisting of pop-up, video, image, text, audio, and banner.

In another particular illustrative embodiment the subscriber categories further include demographic data and from a subscriber profile for the subscriber. In another particular illustrative embodiment the subscriber categories further include location demographic data from a location determined by a dynamic host configuration protocol (DHCP) monitoring system.

In a particular illustrative embodiment a system for selecting a host web site for hosting advertising data is disclosed. The system includes a processor in data communication with a computer readable medium; and a computer program stored in the computer readable medium for execution by processor. The computer program further includes instructions to characterize in a data communications network data communications for a plurality of end user devices for each of a plurality of subscribers to the data communication network between the data communication network and each of a plurality of potential host web sites, instructions to profile each of the plurality of potential host web sites for advertising performance based on the characterizing data communications and subscriber profile data for the plurality of subscribers stored in the data communications network and instructions to select a subscriber profile for the one of the plurality of potential host web sites as a selected host web site for the advertising data based on the selected host web site advertising performance.

In another particular illustrative embodiment the instructions to profile further includes instructions to rank the plurality of potential host web sites for advertising performance based on data selected from the group consisting of sales by advertising type, sales by advertising category, sales by demographic category, sales by advertising type in demographic category, related sales by advertising type and advertising category in demographic category, direct sales by advertising type and category in demographic category; total visitors in demographic category.

In another particular illustrative embodiment the data communications network is an internet protocol television (IPTV) network and characterizing the data communications further comprises characterizing transactions between IPTV network subscribers and the plurality of potential host web sites into categories selected from the group consisting of advertising categories, advertising types and subscriber categories.

In another particular illustrative embodiment the transactions are characterized based on a transaction type selected from the group consisting of direct sales, related sales, click through, number of visits to a web site, duration of visit on a web site and subsequent related visit to an advertiser web site hosted by a potential host web site.

In another particular illustrative embodiment the advertising categories are selected from the group consisting of sports, fashion, finance and news and the advertising types are selected from the group consisting of pop-up, video, image, text, audio and banner. In another particular illustrative embodiment the subscriber categories further include demographic data and from a subscriber profile for the subscriber. In another particular illustrative embodiment the subscriber categories further include location demographic data from a location determined by a dynamic host configuration protocol (DHCP) monitoring system.

In a particular illustrative embodiment a computer readable medium containing a computer program for selecting a host web site for hosting advertising data is disclosed. The computer program further includes instructions to characterize in a data communications network data communications the data communication network between the data communication network and each of a plurality of potential host web sites, instructions to profile each of the plurality of potential host web sites for advertising performance based on the characterizing data communications transactions and subscriber profile data for the plurality of subscribers stored in the data communications network; and instructions to select a subscriber profile for the one of the plurality of potential host web sites as a selected host web site for the advertising data based on the selected host web site advertising performance.

In another particular illustrative embodiment the instructions to profile further includes instructions to rank the plurality of potential host web sites for advertising performance based on data selected from the group consisting of sales by advertising type, sales by advertising category, sales by demographic category, sales by advertising type in demographic category, related sales by advertising type and advertising category in demographic category, direct sales by advertising type and category in demographic category; total visitors in demographic category.

In another particular illustrative embodiment the data communications network is an internet protocol television (IPTV) network and characterizing the data communications further includes characterizing transactions between IPTV network subscribers and the plurality of potential host web sites into categories selected from the group advertising categories, advertising types and subscriber categories.

In another particular illustrative embodiment the transactions are characterized based on a transaction type selected from the group consisting of direct sales, related sales, click through, number of visits to a web site, duration of visit on a web site and subsequent related visit to an advertiser web site hosted by a potential host web site.

In another particular illustrative embodiment the advertising categories are selected from the group consisting of sports, fashion, finance and news and the advertising types are selected from the group consisting of pop-up, video, image, text, audio and banner.

In another particular illustrative embodiment the subscriber categories further include demographic data and from a subscriber profile for the subscriber. In another particular illustrative embodiment the subscriber categories further include location demographic data from a location determined by a dynamic host configuration protocol (DHCP) monitoring system.

In a particular illustrative embodiment a data structure embedded in a computer readable medium is disclosed. The data structure includes a first field for containing data ranking potential host web sites by advertising performance based on characterizing data in a data communications network for a plurality of end user devices for each of a plurality of subscribers to the data communications network, between the data communications network and each of a plurality of potential host web sites, user demographics, advertising category and advertising type.

In another particular illustrative embodiment the data structure further includes a second field for containing data indicating sales by advertising type and advertising category for the potential host web site. In another particular illustrative embodiment the data structure further includes a third field for containing data indicating sales related by advertising type and advertising category for the potential host web sites.

The present disclosure describes a system and method to monitor subscriber network data communications for profiling web sites visited by the subscribers. The data communications and transactions performed in response to the data communications may be referred to collectively as “subscriber activity data.” The subscriber activity data is used to generate profiles for web sites hosting advertising viewed by the subscribers. The subscriber activity data can be used in conjunction with and to supplement network data from combine data sources. For example, in a particular illustrative embodiment, the subscriber activity data is used to supplement data from Domain Naming System (DNS) server logs, Netflow Reports (generating network statistical data) and Deep Packet Inspection (DPI) for systems and methods (Key Word, Click, and on-line purchase correlation) to provide content publisher or host website profiling. NetFlow Analyzer is a web-based bandwidth monitoring tool that uses data exported from network routing devices, to analyze network traffic and report on bandwidth usage across the network. With instant real-time bandwidth usage reports on top applications, conversations, and hosts using bandwidth, NetFlow Analyzer gives valuable insight into bandwidth usage in your enterprise without the complexity and expense involved in deploying hardware/software probes.

NetFlow data exported by network routers and switches contains useful information on IP traffic in an IP network. NetFlow Analyzer collects these NetFlow exports, correlates them, and presents graphs and reports on how bandwidth is used in the communication network.

Deep packet inspection (DPI) is a form of computer network packet filtering that examines the data part of a through-passing packet, searching for non-protocol compliance or predefined criteria to decide if the packet can pass. This is in contrast to shallow packet inspection (usually called just packet inspection) which just checks the header portion of a packet. DPI devices have the ability to look at Layer 2 through Layer 7 of the OSI model. This includes headers and data protocol structures.

A classified packet can be redirected, marked/tagged, blocked, rate limited, and of course, reported to a reporting agent in the network. Many DPI devices also provide the ability to identify flows rather than a packet by packet analysis. DPI allows phone and cable companies to “readily know the packets of information you are receiving online—from e-mail, to websites, to sharing of music, video and software downloads”—as would a network analysis tool. DPI is also increasingly being used in security devices to analyze flows, compare them against policy, and then treat the traffic appropriately (i.e., block, allow, rate limit, tag for priority, mirror to another device for more analysis or reporting).

Content publishers can act as host web sites which serve as primary contact points with advertisers for internet users. Internet users access advertisements placed by the advertiser on host web sites, also referred to herein as content publishers. In an illustrative embodiment internet, advertising models rely on accurate profiling of potential host web sites for selecting an appropriate content publisher website or web sites to host their advertising. In a particular illustrative embodiment content or potential host web site publisher profile is provided containing accurate assessments of web site activity including but not limited to website visitor interest, duration of visit to web sites and other metrics related to on-line surfing discussed below. In addition, the subscriber activity data gathered by an ISP such as IPTV network subscriber monitoring data that can be correlated to geographic location of visitor and associated demographics based on cross references available to subscriber location data available to a broadband service provider. The potential host websites are then ranked by each profile category, for example, visits to a particular advertising category or advertising type by subscribers in a particular demographic category.

The content publisher profile is valuable to Web advertisers and web advertising brokers for use in selecting appropriate content publisher host websites on which to place advertisements. An advertiser wants to reach their desired market demographic efficiently. This means selecting the correct host website for each advertising category, demographic category and advertising type. In order to make intelligent determinations, an illustrative embodiment enables an advertiser to know which one or group of content publishers as potential host websites an advertiser should place advertisements and what type of advertisements to maximize its on-line sales and exposure to a given demographic and advertising category with the least advertising cost.

In an illustrative embodiment, a method is provided to monitor subscriber communications and generate a web site profile based on number of visitors, hits, transactions, direct sales, related sales, unique visitors, etc. for each potential host website visited by a network subscriber. An illustrative system and method enables correlation of visitor demographic categories to websites performance in advertisement categories and advertising types placed on the potential host web sites. The system and method also enables determination of click to advertisement correlation ratio to Web placed advertisements for a group of potential host web sites.

In an illustrative embodiment a system and method are provided that enable correlation of content publisher advertising performance and visitor demographic category data. An illustrative embodiment enables a more auditable and richer publishers' visitor data for a potential host website profile/ranking including temporal (duration) information, related sales, direct sales, geographic information and other visitor demographic details. Advertising performance and visitor demographic data improves the correlation of visitors to a particular page/website.

The Internet and internet protocol television (IPTV) has become a new medium to deliver advertisements after broadcast TV, magazines, and newspapers. According to one source, a banner on a leading portal can cost up to $500,000 per day, about the same as a 30-second sport on a hit TV series. In the past year, net advertisements rose from $9.6 million to $12.5 million. Advertising research forecasts the US online advertising and marketing market to reach $26 billion by 2010. The growth in this market is lead by industry players.

An illustrative embodiment provides the ability to identify potential customers and their respective behavioral patterns online. An illustrative embodiment ranks potential host websites that perform well with the potential customers by profiling the viewers' interests (advertising categories) and background information (demographic data) as long as these subscribers access their potential host websites.

Internet service providers and IPTV service providers can track each of their millions of subscriber' s everyday subscriber activity data (including but not limited to web surfing, DNS lookup, P2P download, ecommerce transactions) and correlate their subscriber's access to different potential host web sites. In an illustrative embodiment the system and method characterize each individual subscriber activity data, including on-line ecommerce activity with each web site visited by each subscriber.

The illustrative embodiment performs extensive publisher (potential host website) profiling and correlation based on service providers' extensive information about subscribers and subscribers' activity so that advertising brokers/advertiser can place advertisements on selected host websites to maximize advertisers' revenue. The goal of publisher profiling is to help advertisers (or advertising brokers, for example advertiser A) to answer the following question: Which one or ones of the host web sites on the World Wide Web should I select so that I can bring the maximum or a historically substantially maximum online sales with the least on-line advertising cost in a particular advertising category to a particular demographic of end user (also referred to herein as “subscriber”). That is, in an illustrative embodiment a system and method creates a profile for and ranks each site (from n available websites, publishers), and determines which web sites potential benefit A's sales or this advertising category for a product or service.

As Internet service providers ISPs and IPTV service providers (IPTV SP) acting as ISPs potentially can obtain and analyze all the subscribers' on-line activities (subscriber activity data), the ISP and IPTV Saps can perform detailed analysis based on behavioral subscriber activity data for each subscriber (identified by IP address or subscriber identifier) each on-line behavior. In an illustrative embodiment, the system and method processes each subscriber's subscriber activity data as a “Key” to correlate the subscriber accessing online advertisements at host web sites and the real purchasing activities incurred by the online advertisements at particular host web sites.

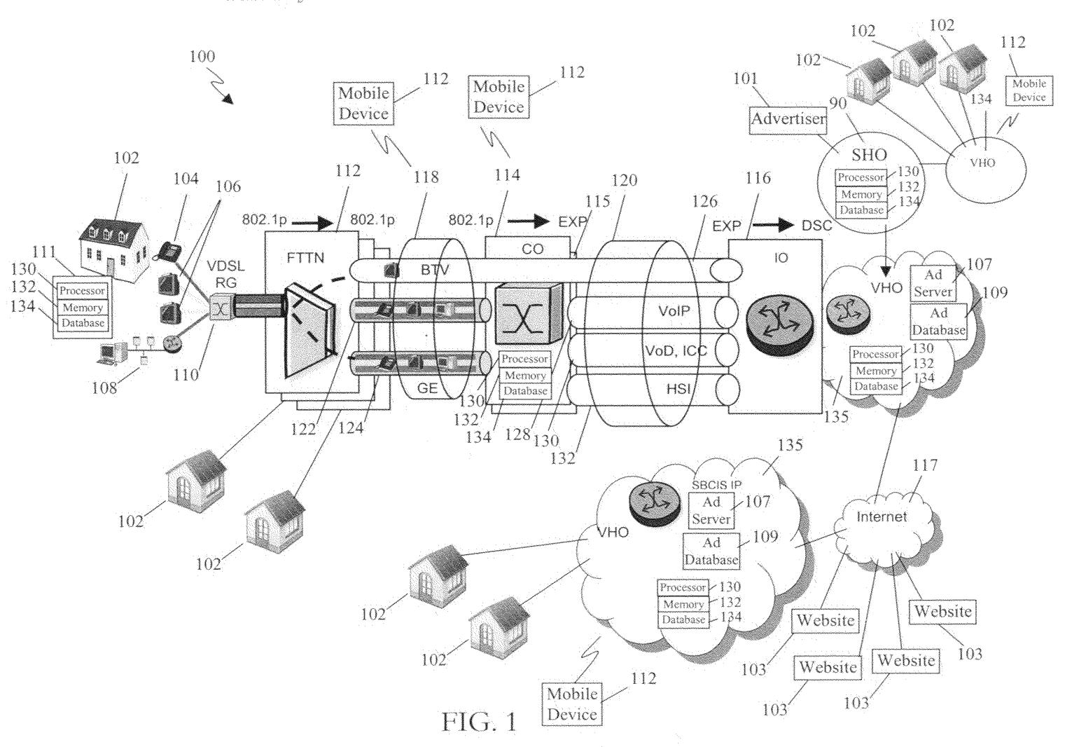

FIG. 1 depicts an illustrative embodiment of a data communication network, providing Internet service and data communications between network subscribers and web sites on the World Wide Web. FIG. 1 shows an illustrative embodiment of a data communication network as an internet protocol television (IPTV) network 100 also providing voice over internet protect (VoIP) service and ISP service. The IPTV network is utilized to deliver video, audio, text and image data streams to an end user household 102 from an IPTV network 100. As shown in FIG. 1 household 102 utilizes end user devices that interact with the IPTV system which includes voice over internet protocol (VoIP) and internet data services. These end user devices include a VoIP telephone 104, IPTV displays 106 with integrated remote controllers, mobile devices 112 and internet protocol (IP) data devices such as personal computers 108. In an illustrative embodiment, each of these end user devices connects to the IPTV/VoIP/Internet data services system (hereinafter collectively referred to as the “IPTV network”) through a very high bit rate digital service line residential gateway (VDSL RG) 110. The mobile devices may also connect through wireless networks to servers in the IPTV network.

In an illustrative embodiment, the IPTV network hierarchically distributes video, audio, text and image data streams from a super head end (SHO) 90, to a video head end (VHO) 135, to intermediate offices 116, to central offices (CO) 114 to gateways such as regional gateway 110 to end user devices such as STB 111 or mobile devices 112. Other gateways and digital data delivery may be used other than the IPTV network shown in the illustrative embodiment. Each super head end (SHO/super regional server), video head end (VHO/regional server), intermediate office (IO/intermediate server), central office (CO/local server), gateway or residential gateway (RG) and end user device (for example a set top box 111 with remote control) includes computer readable medium (memory) 130, processor 132, and a database 134. An illustrative embodiment is applicable to any server in a hierarchical network or set of interconnected servers, whether such servers are designated as super regional, regional, local or another designation.

The residential gateway (RG) or local gateway associated with a commercial building is connected at the residence 102 or commercial site through fiber to the node (FTTN) connections 112. In an illustrative embodiment, these FTTN connections split the device signals and data over three separate lines. These three separate lines comprise business television (BTV) 126, cell phones, VoIP, IPTV services and internet data services 122, and VoIP, IPTV services and internet data services 124. Data over gigabyte Ethernet connection 118 carrying VoIP, IPTV and internet services over lines 122 and 124 connect to a router 125 at a central office (CO) 114 server in the IPTV network. The router 125 connects to a 10 gigabyte Ethernet connection 120.

In an illustrative embodiment, multiple IPTV subscribers at end user devices multiple residences 102 and mobile devices 112 connect to the Internet 117 via the IPTV network 100. Each of the IPTV subscribers communicates with multiple web sites 103 via the internet 117. Processors 130 at each VHO monitor the data communications (subscriber activity data) between the end user devices and the websites 103. The monitoring of subscriber activity data can be performed at any IPTV server (CO, IO, VHO, SHO) via a processor 130 located at each IPTV server. Reporting of subscriber activity data at each hierarchical IPTV server is reported up to the next IPTV server in the hierarchy and aggregated for all IPTV subscribers and web sites visited by the IPTV subscribers. The aggregated subscriber activity data stored in a data base 132 in computer readable medium (memory) 130 at a server in the IPTV network.

The 10 gigabyte Ethernet connection 120 carries VoIP 128, video on demand (Void), and high speed internet (HSI) data 132 to router 116. Router 116 connects to a regional server, video head end (VHO) 135 which is a part of the IPTV network. There may be sub-regional servers such as the central office server (CO) between the regional server (VHO) and the end user device (STB). The VDSL RG 110 Data communications between end user devices 108, 104, 106 and 112 and web sites 103 are captured in a database 138 and reviewed and then sent to a database 132 which is associated with a regional VHO 135. The data base can be associated with any server in the IPTV network.

The database 132 is accessible over the Internet by or located at the IPTV servers at a VHO, SHO, CO, 10 or at an end user device such as a set top box (STB) 111 at household 102. In an illustrative embodiment, as shown in FIG. 1, data communications between end user devices and the IPTV network are transmitted over FTTN connections as 802.1p data. 802.1p is an IEEE standard for providing quality of service (Quest) in 802-based networks. 802.1 p uses three bits to allow switching to reorder packets based on priority level. It also defines the Generic Attributes Registration Protocol (GARP) and the GARP VIAN Registration Protocol (GVRP). GARP lets client stations request membership in a multicast domain, and GVRP lets them register into a VLAN. 802.1p is an IEEE extension of 801.10. It is the specification for the use of MAC-layer bridges in filtering and expediting multicast traffic. Prioritization of traffic is accomplished through the addition of a 3-bit, priority value in the frame header. Eight topology-independent priority values (0-7) are specified, with all eight values mapping directly into 802.4 and 802.6. Switches that support 8021P and 802.1Q provide a framework for bandwidth prioritization. Essentially one can assign a priority to the type of traffic with IEEE 802.1p class-of-service (Coos) values and these allow network devices along the way to recognize and deliver high-priority traffic in a predictable manner. When congestion occurs, Quest drops low-priority traffic to allow delivery of high-priority traffic.

As shown in FIG. 1, differentiated services is a set of technologies proposed by the IETF (Internet Engineering Task Force) which would allow Internet and other IP-based network service providers to offer differentiated levels of service to individual customers and their information streams. On the basis of a Diffusive Code Point (DSCP) marker in the header of each IP (Internet Protocol) packet, the network routers would apply different Per-Hop Behaviors (PHBs). In other words, for an additional charge, DiffServe would allow service providers to provide a certain user with a preferential Grade of Service (GoS) for all packet traffic with appropriate indicators in the packet headers. The preferential GoS, which is only attempted and not guaranteed, would include a lower level of packet latency (delay), as those packets would advance to the head of a packet queue in a buffer should the network suffer congestion. RSVP (Resource ReserVation Protocol), a developing protocol, is an element of DiffServe.

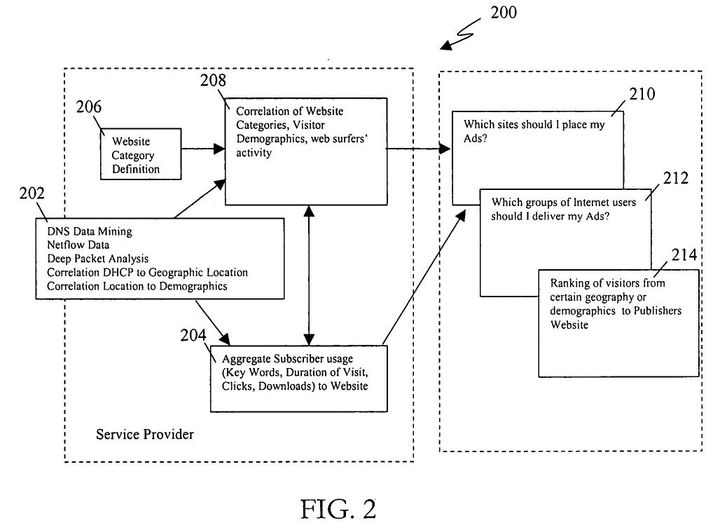

FIG. 2 shows the high-level organization of Internet or IPTV service provider based advertising service framework. Block 202 shows the data input to the IPTV system service provider (SP) based advertising framework: domain naming service (DNS) Data Mining, Netflow Data, Deep Packet Analysis results, Correlation of DHCP to geographic location and correlation of geographic location to demographics category. The demographics are based on subscriber profiles 134 collected for the end user, and web browsing history for purchases and interests. Each subscriber is associated with a plurality of end user devices VoIP telephone 104, IPTV display with an integrated remote control, mobile devices 112 and IP data devices such as PCs 108. Subscriber activity data for each of the end user devices associated with each particular subscriber as characterized by transaction and stored in a subscriber profile associated with the particular subscriber. Demographic categories can include but are not limited to language spoken, geographic location, income, gender, family size, marital status, occupation, age and gender of family members, etc. Block 204 shows aggregate subscriber usage, subscriber activity data, and interests (in Internet browsing, file download, search, duration of web visit, clicks, on-line e-commerce activity, etc.) associated with a particular potential host website.

Based on website category information, in block 208 the system and method correlates website categories, visitor demographics, advertising category, advertising type and subscriber activity data each advertising publishers' advertisements effectiveness to each group of subscribers based on subscriber demographics.

An illustrative embodiment of a system and method determine on which potential host website or web sites an advertiser of a given type should place advertisements to reach a group of subscribers in a particular demographic in a particular advertising category at block 210. In addition, in an illustrative embodiment, visitors to a web site can be identified by demographic category to the system and method can also identify the potential customers (to each publishers' website) for use in determining which groups of Internet users (content providers' visitors) to deliver advertisements in which advertising category and in which advertising type at block 212. In addition, in an illustrative embodiment, visitors to a potential host web site can be identified by demographic category to the system and method can also identify the potential customers (to each publishers' website) based on geographic location or demographics information based on the location or a subscriber profile of visitors to the web site at block 214.

For example, by analyzing the data communications, such as HTTP message exchanges between IPTV network subscribers and websites, the interaction among the subscribers for each web site browsing on-line shopping activities and transactions can be identified. In an example scenario, a subscriber first accesses a potential host website X (a host web site publisher) with an advertisement for advertiser A, accesses advertiser A's website and performed purchase from advertiser A. In an illustrative embodiment, the system and method infer that the publishing of A's advertisement at publisher X benefits this on-line purchase activity and this transaction is characterized as a direct sale to the subscriber from advertiser A via potential host web site X. Related sales are logged for the potential host website X when a subscriber visits the advertiser A without first visiting the potential host website and purchases a product, from an advertiser A previously presented to the subscriber hosted by a potential web or service site within a week of the subscriber visiting the potential host web site and visiting advertiser A from web site X. All subscriber activity data including direct sales and indirect sales are monitored for advertising category, advertising type, subscriber demographics, duration of visit and visits with and without purchase to each web site and each advertisement presented to each subscriber visiting each web site.

By correlating potential host web sites and different on-line advertisers, an illustrative system and method can infer each publisher's effectiveness and performance in providing a specific category of advertisements to a specific demographic category, including but not limited to data indicating language spoken, income, age, geographic location or gender. Based on this demographic category information, service providers can provide service recommendations to on-line advertisers (as to which potential host web site to place which advertising category and advertising type of advertisements for which demographic category) and become effective advertising brokers.

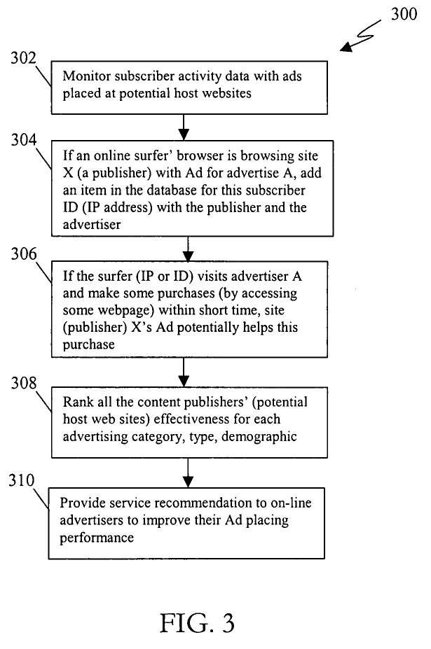

FIG. 3 shows an example data flow for an illustrative embodiment of an ITPV service provider-based potential host web site profiling system and method. As shown in block 302 in an illustrative embodiment, the system and method monitor subscriber activity data between subscribers, web sites and advertising hosted by the web sites. As shown in block 304, if an online surfer or end user device is browsing or visiting a web site X (a potential host web site) is presented with a particular advertisement A for advertiser B, a data item recording this transaction or event is added to a profile for web site X for the subscriber (identifier or IP address) and advertiser B. The transaction type (purchase, visit without purchase, etc.), advertising type, advertising category, demographic data are also recorded in the profile for website X. As shown in block 306, if the subscriber visits advertiser A and makes a purchase via accessing advertiser A web pages within a short time (for example, 5 minutes) a direct sale purchase transaction for the subscriber is attributed to web site X and advertiser B. All communications between subscribers' end user devices and web sites are monitored for characterizing transactions between the subscribers and the web sites. As shown in block 308, the web sites are ranked based on the transactions according to effectiveness for each category of advertising. As shown in block 310 the system and method use the ranking to provide service recommendations to on-line advertisers to improve their advertising placing performance.

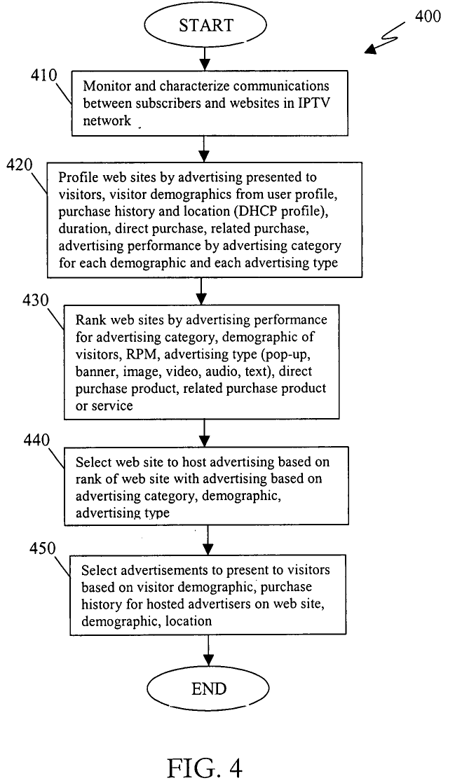

Turning now to FIG. 4, flow chart 400 of functions performed in another particular illustrative embodiment is illustrated. As shown in block 410, in an illustrative embodiment the system and method monitor and characterize communications between IPTV subscribers and web sites in an IPTV network. As shown in block 420, in an illustrative embodiment the system and method generate profiles for web sites by monitoring advertising presented to subscriber visitors. The web site profiles include subscriber visitor demographics from subscriber profiles located in data base 134. The system and method further analyze the data communications between the subscribers and web sites to determine purchase history including direct sales and related sales for advertisements hosted by the web site and presented and visited by subscribers. The system and method further analyze the data communications, transactions and subscriber profile to determine advertising performance by advertising category and advertising type for each demographic category.

As shown in block 430, in an illustrative embodiment the system and method then rank the web sites by advertising performance by advertising category, demographics of visitors, revenue per 1000 visitors (RPM), advertising type (pop-up ads, banner ads, image ads, video ad, audio ads and text ads), direct purchases of products and services and related purchases of products and services. As shown in block 440, the system and method select a web site to host potential advertising based on a ranking of the potential host web site performance with potential advertising based on advertising category, demographic category and advertising type of the potential advertising to be hosted. As shown in block 450, in an illustrative embodiment, the system and method select advertisements to present to subscribers or visitors based on visitor demographics, purchase history for advertisers hosted by the web site and subscriber location and demographics correlated to the location.

An illustrative embodiment provides online advertising publishers profiling for Internet service providers (ISPs) such as an IPTV network to provide advanced advertisement services. ISP and IPTV service providers can access volumes and diverse information from all subscribers' online activities with all the on-line publishers and advertisers. An illustrative embodiment enables service providers to be more effective on-line advertisement brokers or provide effective information to on-line web brokers. In another illustrative embodiment, given that an IPTV subscriber explicitly requests to have additional data monitored, IPTV subscriber activity data may also include analysis of additional data such as reverse look up of business names associated with subscriber telephone calls, text messages, instant messages and television or video watching historical data. This analysis of additional data is used to further characterize the IPTV subscribers for advertising category and demographic category and thus add to the profile of potential host web sites visited by the subscribers.

By correlating performance of different potential host websites with different advertising categories and advertising types, based on visitors, sales, click through, and visitor demographics, transactions, etc. service providers can provide improved service and help to ensure that the ISPs recommend host web site publishers that bring the desired type of visitors and sales to on-line advertisers placed in a particular advertising category on a particular web site. The correlation is based on observing and correlating each ITPV subscriber's activities captured and stored as subscriber activity data, including actual purchases from a web site, an illustrative embodiment can substantially reduce the impact from click-fraud (click through without purchase).

An illustrative system and method gathers subscriber activity data from subscriber end user device communications with web sites through the IPTV system which enables a more auditable and richer publisher profile and ranking including temporal information, geographic information and other demographic detail. This collection of data from end user communications improves the correlation of visitors to a particular page/website to demographics/geography. In addition, this correlation will be not restricted to web surfers' security concerns.

Some embodiments described herein are associated with a “Dynamic Host Configuration Protocol” or “DHCP”. As used herein, the terms “Dynamic Host Configuration Protocol” and “DHCP” may be used interchangeably and generally refer to a framework, protocol, and/or method for automating, managing, and/or conducting the configuration of network devices. An example of such a protocol is that defined by the Internet Engineering Task Force (IETF) Dynamic Host Configuration Protocol for IPv6 (DHCPv6), RFC 3315, Droms et al., July, 2003. Other versions of DHCP and other configuration protocols may be used in accordance with some embodiments.

By way of example, a network client and a network server operating on a network may exchange DHCP messages to assign an Internet Protocol (IP) address to the network client upon connection of the network client to the network. As used herein, the term “DHCP message” generally refers to any string, code, command, signal, packet, datagram, information, and/or other communication associated with the configuration of a network device. Examples of DHCP messages and message formats may be found in the specifications for DHCPv6 as cited above, and are also briefly described herein. Formats other than those referenced and/or described herein may also be used without deviating from the scope and purpose of the presented embodiments.

Some embodiments are associated with “locations”, “physical locations”, or “location information”. As used herein, the phrases “location” or “physical location” may be used interchangeably and may refer to any site, spot, point, place, and/or locale where an object or other device resides, occupies, exists, or can otherwise be associated with. As used herein, the term geographic or location may refer to any data, string, coordinate, reference, identifier, and/or other information related to the location of a particular object, device, and/or grouping or other combination of objects and/or devices. Examples of location information include, but are not limited to, planar, cylindrical, polar, geodetic, and/or other coordinates, location descriptions or other identifiers, and/or any combination thereof.

In addition, some embodiments are associated with a “network device”. As used herein, the phrase “network device” may refer to any device that can communicate via a network. Examples of network devices include a Personal Computer (PC), a workstation, a server, a printer, a scanner, a facsimile machine, a copier, a Personal Digital Assistant (PDA), a storage device (e.g., a disk drive), a hub, a router, a switch, and a communication device (e.g., a modem, a wireless phone, etc.). Network devices may comprise one or more network components. As used herein, the term “network component” may refer to a network device, or a component, piece, portion, or combination of network devices. Examples of network components may include a Static Random Access Memory (SRAM) device or module, a network processor, and a network communication path, connection, port, or cable.

Referring back to FIG. 1, a block diagram of an IPTV network 100 for facilitating electronic communication is depicted for use in explanation, but not limitation, of described embodiments. Upon reading this disclosure, those skilled in the art will appreciate that different types, layouts, quantities, and configurations of systems may be used.

System 100 may comprise, for example, one or more end user devices connected to a DHCP server processor 130 and data base 132 via a network 100. The end user devices may be or include any type or configuration of network devices including, for example, client computers such as corporate workstations. In some embodiments, the end user devices may be or include one or more components of a network device. The DHCP server may be or include a network server processor 130 and data base 134 or other network device capable of managing, sending, and/or receiving DHCP messages. In some embodiments, the DHCP server processor may be located at an IPTV server such as a VHO 135, CO 114 or IO 116. A geographic location with which a DHCP server processor is associated may be used to determine geographic location for a user.

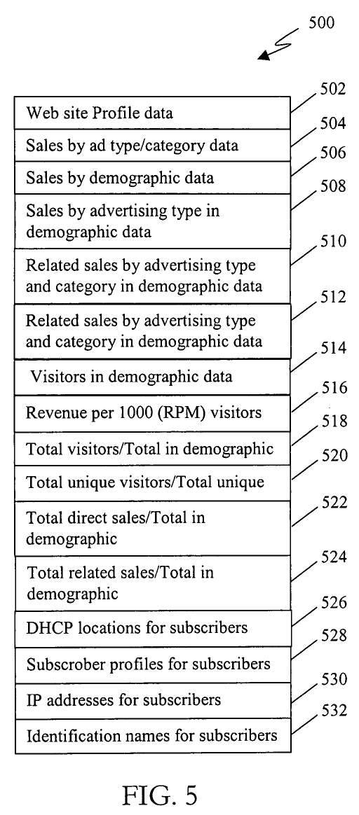

Turning now to FIG. 5, an illustrative embodiment of a data structure 500 is depicted. The data structure is embedded in a computer readable medium such as a memory for providing a functional and structural interrelationship between the data structure, the data in the data structure and a computer or process. The term computer readable medium is used herein synonymously with the term machine readable medium. The fields of the data structure may be collocated or separately stored and accessed in different locations. As shown in FIG. 5, in an illustrative embodiment, the data structure includes but is not limited to a first field for containing data indication a web site profile and a ranking for host web sites by advertising performance and user demographics by advertising category and type. Each potential host web site contacted by an end user in the IPTV network is identified by host web site identifier data (“identifier”), profiled and ranked according to each of the fields 504-532 as shown in FIG. 5. In an illustrative embodiment, the data structure further includes, but is not limited to a second field 504 as shown for containing data indicating sales by advertising type and advertising category for a particular host web site. All sales data include separate counts (data) for direct sales and related sales. In an illustrative embodiment, the data structure further includes, but is not limited to a third field 506 is shown for containing data indicating sales by advertising type and advertising category for a particular host web site. Advertising types can include but are not limited to banner advertisements, pop up advertisements, video, audio, selectable icon, image and text advertisements presented to a visitor at a host web site. Advertising category includes but is not limited to data indicating a subscriber category of interest in an advertising category such as sports, finance, fashion, medicine, automobiles, real estate and food.

In an illustrative embodiment, the data structure further includes, but is not limited to a fourth field 508 for containing data indicating sales by advertising type in a particular demographic. Thus, a number of sports related sales, e.g., Peyton Manning football jerseys sold to males 18-21 using video pop up advertisements is represented in field 508. In an illustrative embodiment, the data structure further includes, but is not limited to a fifth field 510 for containing data indicating related sales by adverting type and category in all demographic categories for a web site identified in field 502. In an illustrative embodiment, the data structure further includes, but is not limited to a sixth field 512 for containing data indicating related sales by advertising type and advertising category in all demographic categories.

In an illustrative embodiment, the data structure further includes, but is not limited to a seventh field 514 for containing data indicating a number of visitors to a web site identified in field 502. In an illustrative embodiment, the data structure further includes, but is not limited to a eighth field 516 for containing data indicating a revenue per 1000 visitors (RPM) to a web site identified in field 502. In an illustrative embodiment, the data structure further includes, but is not limited to a ninth field 518 for containing data indicating a total number of visitors and a total number of visitor in each demographic category to a web site identified in field 502.

In an illustrative embodiment, the data structure further includes, but is not limited to a tenth field 520 for containing data indicating a number of unique visitors to a web site identified in field 502. In an illustrative embodiment, the data structure further includes, but is not limited to a eleventh field 522 for containing data indicating a total direct sales and total direct sales in all demographic categories to a web site identified in field 502. In an illustrative embodiment, the data structure further includes, but is not limited to a twelfth field 524 for containing data indicating a number of visitors to a web site identified in field 502.

In an illustrative embodiment, the data structure further includes, but is not limited to a thirteenth field 526 for containing data indicating a DHCP subscriber locations for subscribers visiting a host web site identified in field 502. In an illustrative embodiment, the data structure further includes, but is not limited to a fourteenth field 528 for containing data indicating subscriber profiles of visitors to a web site identified in field 502. In an illustrative embodiment, the data structure further includes, but is not limited to a fifteenth field 530 for containing data indicating a IP addresses for visitors to a web site identified in field 502. In an illustrative embodiment, the data structure further includes, but is not limited to a sixteenth field 532 for containing data indicating a identifying names for subscribers/visitors to a web site identified in field 502.

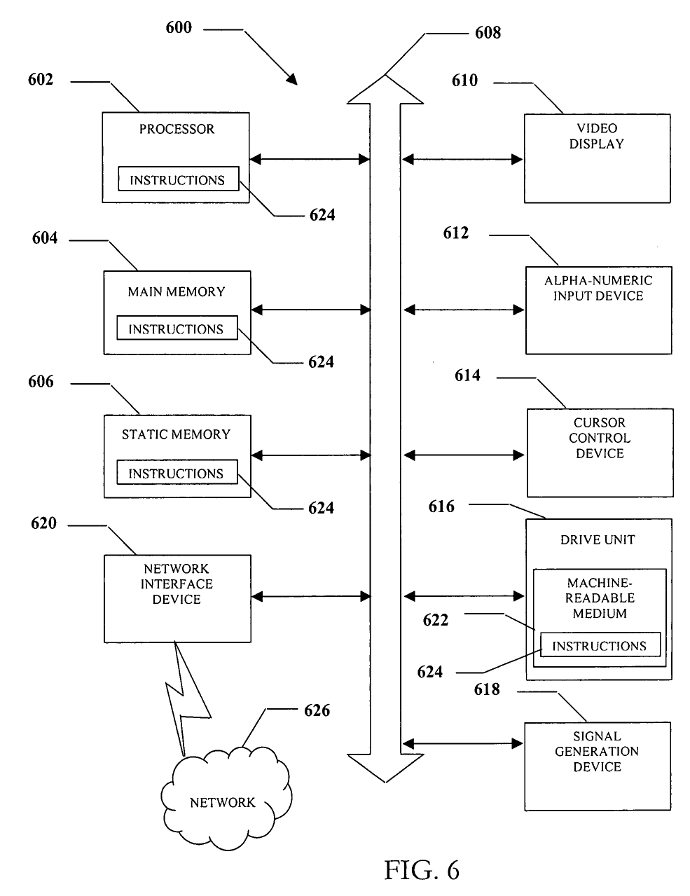

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystals display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface 9.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620. The machine readable medium may also contain a data structure for containing data useful in providing a functional relationship between the data and a machine or computer in an illustrative embodiment of the disclosed system and method.

While the machine-readable medium 622 is shown in an example embodiment to be a single medium, the terms “computer-readable medium” and “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” and “computer-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computerized method for selecting a host web site for hosting advertising data, the method comprising:
characterizing in a data communications network, data communications for a plurality of end user devices for each of a plurality of subscribers to the data communication network between the data communication network and each of a plurality of potential host web sites;
profiling each of the plurality of potential host web sites for advertising performance based on the characterizing data communications and subscriber profile data for the plurality of subscribers stored in the data communications network; and
selecting one of the plurality of potential host web sites as a selected host web site for the advertising data based on the selected host web site advertising performance.

2. The method of claim 1, wherein the profiling further comprises ranking the plurality of potential host web sites for advertising performance based on data selected from the group consisting of sales by advertising type, sales by advertising category, sales by demographic category, sales by advertising type in demographic category, related sales by advertising type and advertising category in demographic category, direct sales by advertising type and category in demographic category and total visitors in demographic category.

3. The method of claim 1, wherein the data communications network is an internet protocol television (IPTV) network and characterizing the data communications further comprises characterizing transactions between IPTV network subscribers and the plurality of potential host web sites into categories selected from the group consisting of advertising categories, advertising types and subscriber categories.

4. The method of claim 3, wherein the transactions are characterized based on a transaction type selected from the group consisting of direct sales, related sales, click through, number of visits to a web site, duration of visit on a web site and subsequent related visit to an advertiser web site hosted by a potential host web site.

5. The method of claim 3, wherein the advertising categories are selected from the group consisting of sports, fashion, finance and news and the advertising types are selected from the group consisting of pop-up, video, image, text, audio, and banner.

6. The method of claim 3, wherein the subscriber categories further comprise demographic data and from a subscriber profile for the subscriber.

7. The method of claim 6, wherein the subscriber categories further comprise location demographic data from a location determined by a dynamic host configuration protocol (DHCP) monitoring system.

8. A system for selecting a host web site for hosting advertising data, the system comprising:
a processor in data communication with a computer readable medium; and
a computer program stored in the computer readable medium for execution by processor, the computer program further comprising instructions to characterize in a data communications network data communications for a plurality of end user devices for each of a plurality of subscribers to the data communication network between the data communication network and each of a plurality of potential host web sites, instructions to profile each of the plurality of potential host web sites for advertising performance based on the characterizing data communications and subscriber profile data for the plurality of subscribers stored in the data communications network and instructions to select one of the plurality of potential host web sites as a selected host web site for the advertising data based on the selected host web site advertising performance.

9. The system of claim 8, wherein in the computer program, the instructions to profile further comprise instructions to rank the plurality of potential host web sites for advertising performance based on data selected from the group consisting of sales by advertising type, sales by advertising category, sales by demographic category, sales by advertising type in demographic category, related sales by advertising type and advertising category in demographic category, direct sales by advertising type and category in demographic category; total visitors in demographic category.

10. The method of claim 8, wherein the data communications network is an internet protocol television (IPTV) network and characterizing the data communications further comprises characterizing transactions between IPTV network subscribers and the plurality of potential host web sites into categories selected from the group consisting of advertising categories, advertising types and subscriber categories.

11. The system of claim 10, wherein the transactions are characterized based on a transaction type selected from the group consisting of direct sales, related sales, click through, number of visits to a web site, duration of visit on a web site and subsequent related visit to an advertiser web site hosted by a potential host web site.

12. The system of claim 10, wherein the advertising categories are selected from the group consisting of sports, fashion, finance and news and the advertising types are selected from the group consisting of pop-up, video, image, text, audio and banner.

13. The method of claim 10, wherein the subscriber categories further comprise demographic data and from a subscriber profile for the subscriber.

14. The system of claim 13, wherein the subscriber categories further comprise location demographic data from a location determined by a dynamic host configuration protocol (DHCP) monitoring system.

15. A computer readable medium containing a computer program for selecting a host web site for hosting advertising data, the computer program further comprising, instructions to characterize in a data communications network data communications the data communication network between the data communication network and each of a plurality of potential host web sites, instructions to profile each of the plurality of potential host web sites for advertising performance based on the characterizing data communications and subscriber profile data stored in the data communications network; and instructions to select one of the plurality of potential host web sites as a selected host web site for the advertising data based on the selected host web site advertising performance.

16. The computer program of claim 15, wherein in the computer program, the instructions to profile further comprise instructions to rank the plurality of potential host web sites for advertising performance based on data selected from the group consisting of sales by advertising type, sales by advertising category, sales by demographic category, sales by advertising type in demographic category, related sales by advertising type and advertising category in demographic category, direct sales by advertising type and category in demographic category; total visitors in demographic category.

17. The computer program of claim 15, wherein the data communications network is an internet protocol television (IPTV) network and characterizing the data communications further comprises characterizing transactions between IPTV network subscribers and the plurality of potential host web sites into categories selected from the group advertising categories, advertising types and subscriber categories.

18. The computer program of claim 17, wherein the transactions are characterized based on a transaction type selected from the group consisting of direct sales, related sales, click through, number of visits to a web site, duration of visit on a web site and subsequent related visit to an advertiser web site hosted by a potential host web site.

19. The computer program of claim 17, wherein the advertising categories are selected from the group consisting of sports, fashion, finance and news and the advertising types are selected from the group consisting of pop-up, video, image, text, audio and banner.

20. The computer program of claim 17, wherein the subscriber categories further comprise demographic data and from a subscriber profile for the subscriber.

21. The computer program of claim 20, wherein the subscriber categories further comprise location demographic data from a location determined by a dynamic host configuration protocol (DHCP) monitoring system.

22. A data structure embedded in a computer readable medium, the data structure comprising:
a first field for containing data ranking potential host web sites by advertising performance based on characterizing data in a data communications network for a plurality of end user devices for each of a plurality of subscribers to the data communications network, between the data communications network and each of a plurality of potential host web sites, user demographics, advertising category and advertising type.

23. The data structure of claim 22, further comprising, a second field for containing data indicating sales by advertising type and advertising category for the potential host web site.

24. The data structure of claim 22, further comprising, a third field for containing data indicating sales related by advertising type and advertising category for the potential host web sites.
